(19) United States
(12) Patent Application Publication
(10) Pub. No.: US 2026/0100421 A1
(43) Pub. Date: Apr. 9, 2026

(54) BATTERY AND ELECTRIC APPARATUS INCLUDING SAME

(71) Applicant: Ningde Amperex Technology Limited, Ningde (CN)

(72) Inventors: Song LI, Ningde (CN); Nan JIANG, Ningde (CN); Qiao ZENG, Ningde (CN)

(73) Assignee: Ningde Amperex Technology Limited, Ningde (CN)

(21) Appl. No.: 19/417,564

(22) Filed: Dec. 12, 2025

Related U.S. Application Data
(63) Continuation of application No. PCT/CN2023/099741, filed on Jun. 12, 2023.

(51) Int. Cl. H01M 10/0585; H01M 50/105

(52) U.S. Cl. CPC H01M 10/0585; H01M 50/105; H01M 2220/30

(57) ABSTRACT

A battery includes an electrode assembly, a housing accommodating the electrode assembly, and a first layer including an insulating material. The electrode assembly includes a first electrode sheet and a second electrode sheet that are stacked and adjacently disposed along a fourth direction. The first electrode sheet includes a first edge extending along a first direction, a second edge extending along a second direction perpendicular to the first direction, and a third edge extending along a third direction intersecting both the first direction and the second direction, the third edge including a first end connected to the first edge and a second end connected to the second edge. The first layer is adhered to the first electrode sheet and includes a first border extending along the first direction and a second border extending along the second direction and connected to the first border.

### CROSS REFERENCE TO RELATED APPLICATION

This application is a continuation application of International Application No. PCT/CN2023/099741 filed on Jun. 12, 2023, the contents of which are incorporated herein by reference in its entirety.

### TECHNICAL FIELD

The present application relates to the field of energy storage apparatuses, and in particular, to a battery and an electric apparatus including the same.

### BACKGROUND

Currently, battery cells are primarily manufactured through lamination and winding processes, with stacked cells being widely used due to their numerous advantages, such as high rate capability and high energy density. However, during the production process, the edges or corners of the electrode sheets of the cells may experience curling or warping.

### SUMMARY

An object of the present application is to provide a battery that can reduce the risk of curling or warping of electrode sheets.

According to a first aspect of the present application, a battery is provided, including an electrode assembly, a housing accommodating the electrode assembly, and a first layer including an insulating material. The electrode assembly includes a first electrode sheet and a second electrode sheet that are stacked and adjacently disposed. The first electrode sheet includes a first edge extending along a first direction, a second edge extending along a second direction perpendicular to the first direction, and a third edge extending along a third direction intersecting both the first direction and the second direction, where the third edge includes a first end connected to the first edge and a second end connected to the second edge. The first layer is adhered to the first electrode sheet and includes a first border extending along the first direction and a second border extending along the second direction and connected to the first border. When observed along a fourth direction perpendicular to both the first direction and the second direction, the first border and the second border each include a portion overlapping with the first electrode sheet, and the first border further includes a portion spaced apart from the first edge and the second edge and connected to the third edge. The fourth direction is a stacking direction of the first electrode sheet and the second electrode sheet, and in the fourth direction, the first electrode sheet is located at the outermost layer of the electrode assembly.

The first electrode sheet of the present application is provided with the third edge connecting the first edge and the second edge, which extend along mutually perpendicular directions, increasing the contact area between the corner of the first electrode sheet and the housing, and reducing the impact force of the corner of the electrode assembly on the housing, thereby reducing the risk of the housing cracking and leaking due to the impact from the electrode assembly. Moreover, the first layer is provided such that the first border and the second border each include a portion overlapping with the first electrode sheet, and the first border further includes a portion spaced apart from the first edge and the second edge and connected to the third edge, enabling the first layer to constrain the third edge forming the corner of the first electrode sheet in the fourth direction, thus reducing the risk of curling or warping of the corner where the third edge of the first electrode sheet is located during production. Therefore, the battery of the present application reduces the risk of the housing cracking and leaking due to the impact from the electrode assembly while also reducing the risk of curling or warping of the corner of the first electrode sheet.

In a possible implementation, in the second direction, a first distance from the first end to the first border is less than a second distance from the second end to the first border, increasing the contact area between the first layer and the third edge, further reducing the risk of curling or warping of the corner where the third edge of the first electrode sheet is located.

In a possible implementation, in the first direction, a third distance from the first end to the second border is greater than a fourth distance from the first end to the second end.

In a possible implementation, the first border and the third edge are connected at a first intersection point, and in the first direction, a fifth distance from the first end to the first intersection point is less than a sixth distance from the second end to the first intersection point.

In a possible implementation, the first electrode sheet further includes a fourth edge extending along the first direction and opposite to the first edge in the second direction, and a fifth edge extending along a fifth direction intersecting both the first direction and the second direction and different from the third direction, and connected to the third edge and the fourth edge. The first layer further includes a third border extending along the first direction and opposite to the first border in the second direction. When observed along the fourth direction, the third border includes a portion overlapping with the first electrode sheet and a portion spaced apart from the second edge and the fourth edge and connected to the fifth edge. This arrangement of the first layer enables the first layer to constrain the fifth edge forming the corner of the first electrode sheet in the fourth direction, reducing the risk of curling or warping of the corner where the fifth edge of the first electrode sheet is located.

In a possible implementation, when observed along the fourth direction, the second electrode sheet includes a first exposed portion exposed from the first electrode sheet, making the area of the second electrode sheet greater than that of the first electrode sheet, and reducing the risk of lithium precipitation at the negative electrode. In a possible implementation, when observed along the fourth direction, the first layer further includes a portion overlapping with the first exposed portion, increasing the contact area between the first layer and the electrode assembly, thereby enhancing the adhesion between the first layer and the electrode assembly and reducing the risk of the first layer detaching.

In a possible implementation, the electrode assembly further includes a separator disposed between the first electrode sheet and the second electrode sheet. When observed along the fourth direction, the separator includes a second exposed portion exposed from the first electrode sheet and the second electrode sheet, making the area of the separator greater than that of the first electrode sheet and the second electrode sheet, and reducing the risk of a short circuit due to contact between the first electrode sheet and the second electrode sheet.

In a possible implementation, when observed along the fourth direction, the first layer further includes a portion overlapping with the second exposed portion.

In a possible implementation, the electrode assembly further includes a first surface and a second surface opposite to each other in the fourth direction, and a first end surface connecting the first surface and the second surface, where the first layer is adhered to the first surface, the first end surface, and the second surface.

In a possible implementation, the first electrode sheet is a positive electrode sheet, and the second electrode sheet is a negative electrode sheet.

In a possible implementation, the first layer is a single-sided adhesive or a double-sided adhesive.

In a possible implementation, the battery further includes a first metal plate and a second metal plate, where the first metal plate is electrically connected to the first electrode sheet and extends out of the housing along the first direction, and the second metal plate is electrically connected to the second electrode sheet and extends out of the housing along the first direction. In the first direction, the first metal plate and the first layer are located on opposite sides of the electrode assembly, and the second metal plate and the first layer are located on opposite sides of the electrode assembly.

In a possible implementation, the housing is a packaging bag.

In a possible implementation, the outer surface of the first electrode sheet is a bare foil region.

According to a second aspect of the present application, an electric apparatus is provided, including any one of the batteries described above.

### DETAILED DESCRIPTION

The above and/or additional aspects and advantages of the present application will become apparent and readily understood from the description of embodiments in conjunction with the following drawings, in which:

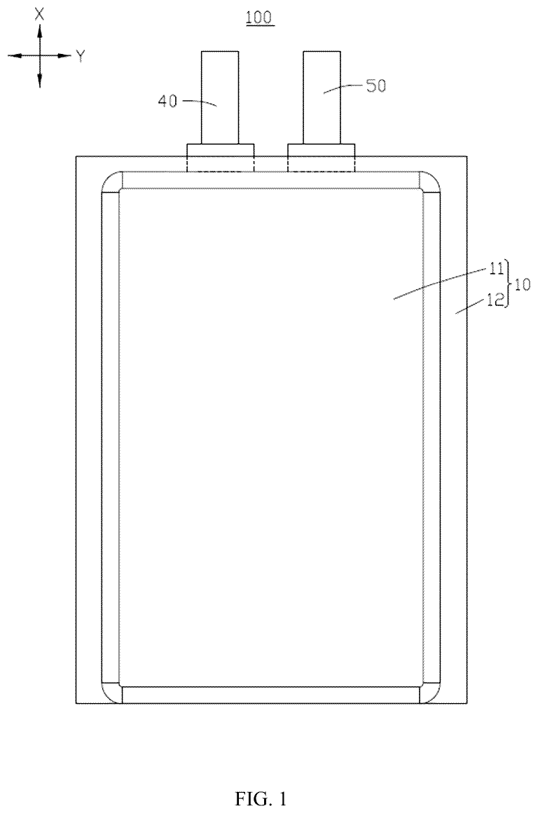

FIG. 1 is a view of a battery along a fourth direction according to an embodiment of the present application.

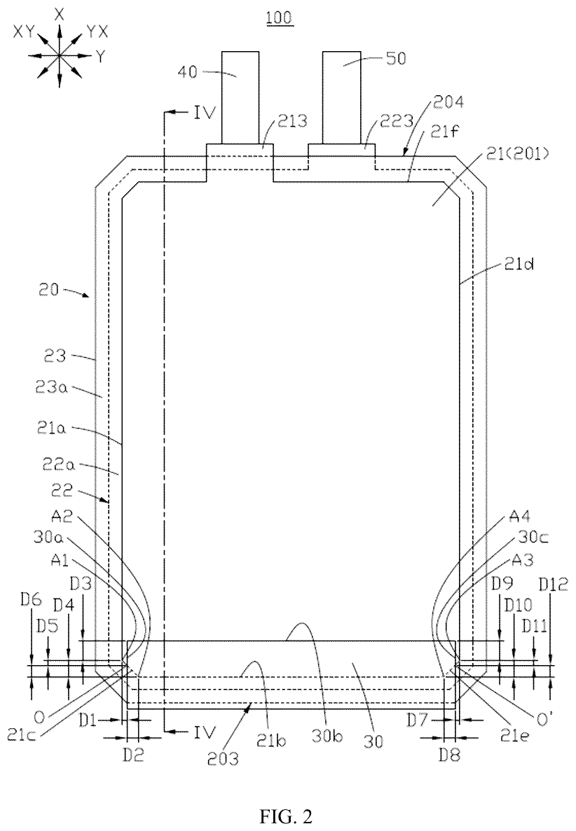

FIG. 2 is a view of an electrode assembly from a first surface along a fourth direction according to an embodiment of the present application.

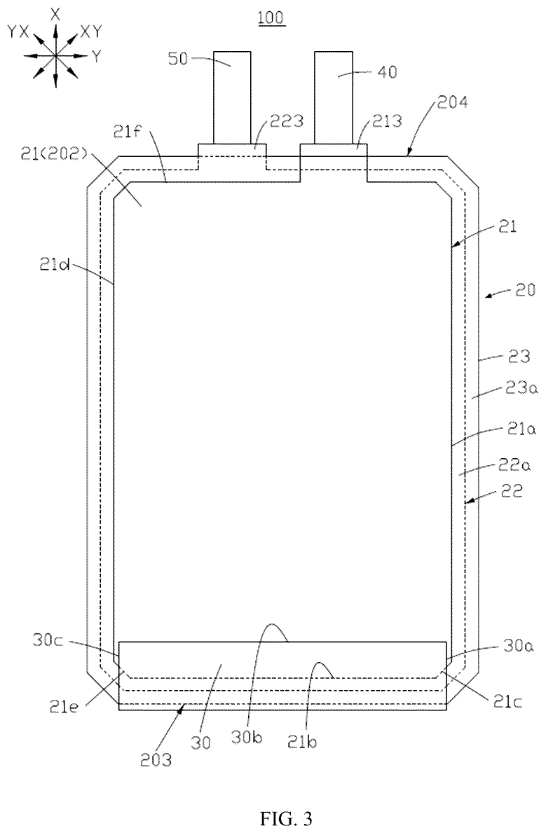

FIG. 3 is a view of an electrode assembly from a second surface along a fourth direction according to an embodiment of the present application.

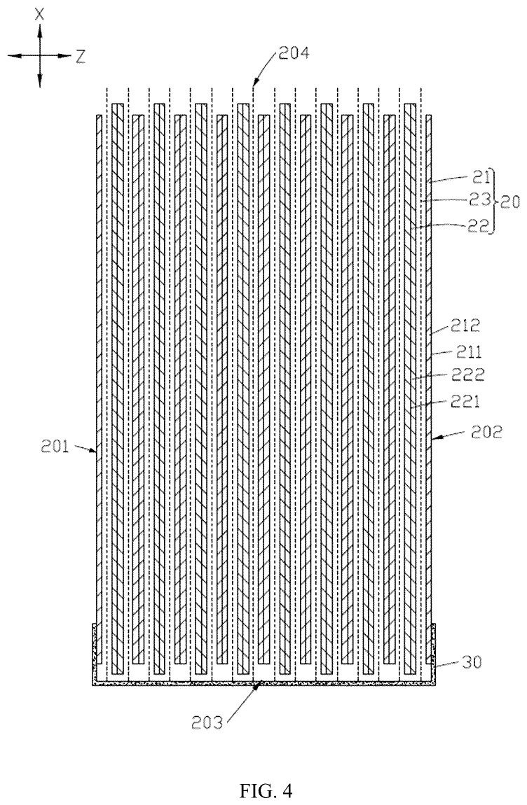

FIG. 4 is a cross-sectional view of the electrode assembly shown in FIG. 2 along IV-IV.

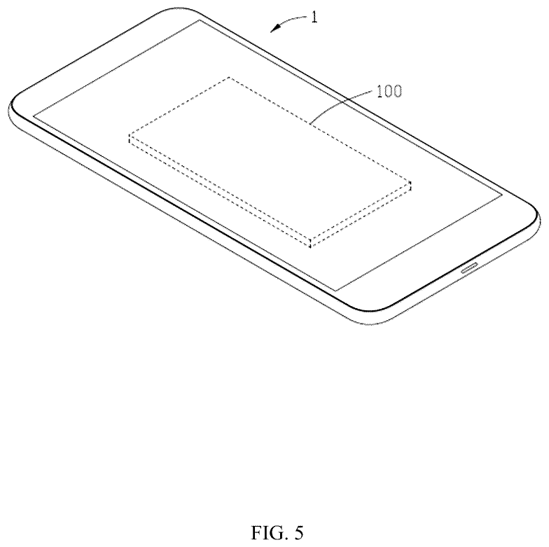

FIG. 5 is a schematic structural diagram of an electric apparatus according to an embodiment of the present application.

### DESCRIPTION OF REFERENCE SIGNS OF MAIN ELEMENTS

| | |
|---|---|
| Battery | 100 |
| Housing | 10 |
| Electrode assembly | 20 |
| First metal plate | 40 |
| Second metal plate | 50 |
| Main body portion | 11 |
| Encapsulation portion | 12 |
| Separator | 23 |
| First electrode sheet | 21 |
| Second electrode sheet | 22 |
| First current collector | 211 |
| First active substance layer | 212 |
| First tab | 213 |
| Second current collector | 221 |
| Second active substance layer | 222 |
| Second tab | 223 |
| First surface | 201 |
| Second surface | 202 |
| First end surface | 203 |
| Second end surface | 204 |
| First layer | 30 |
| First edge | 21a |
| Second edge | 21b |
| Third edge | 21c |
| Fourth edge | 21d |
| Fifth edge | 21e |
| Sixth edge | 21f |
| First border | 30a |
| Second border | 30b |
| Third border | 30c |
| First end | A1 |
| Second end | A2 |
| Third end | A3 |
| Fourth end | A4 |
| First distance | D1 |
| Second distance | D2 |
| Third distance | D3 |
| Fourth distance | D4 |
| Fifth distance | D5 |
| Sixth distance | D6 |
| Seventh distance | D7 |
| Eighth distance | D8 |
| Ninth distance | D9 |
| Tenth distance | D10 |
| Eleventh distance | D11 |
| Twelfth distance | D12 |
| First intersection point | O |
| Second intersection point | O′ |
| First exposed portion | 22a |
| Second exposed portion | 23a |
| Electric apparatus | 1 |
| First direction | X |
| Second direction | Y |
| Third direction | XY |
| Fourth direction | Z |
| Fifth direction | YX |

### DESCRIPTION OF EMBODIMENTS

The technical solutions in some embodiments of the present application are described clearly and in detail below. It is apparent that the described embodiments are some embodiments of the present application, rather than all embodiments. Unless otherwise defined, all technical and scientific terms used herein have the same meanings as commonly understood by those skilled in the technical field of the present application. The terms used in the specification of the present application are only for the purpose of describing specific embodiments and are not intended to limit the present application.

Hereinafter, these embodiments of the present application will be described in detail. However, the present application may be embodied in many different forms and should not be construed as limited to the exemplary embodiments set forth herein. Rather, these exemplary embodiments are provided so that the present application is thorough and detailed and fully conveys the scope to those skilled in the art.

In addition, for brevity and clarity, the sizes or thicknesses of various components and layers in the drawings may be exaggerated. Throughout the text, the same reference numerals refer to the same elements. It should also be understood that when an element A is referred to as being “connected” to an element B, element A may be directly connected to element B, or there may be an intermediate element C, and elements A and B may be indirectly connected to each other.

Further, when these embodiments of the present application are described, the term “may” indicates “one or more embodiments of the present application.”

The technical terms used herein are for the purpose of describing specific embodiments and are not intended to limit the present application. As used herein, the singular forms are intended to include the plural forms as well, unless the context clearly indicates otherwise. It should be understood that the term “include,” when used in this specification, refers to the presence of the stated features, values, steps, operations, elements, and/or components, but does not preclude the presence or addition of one or more other features, values, steps, operations, elements, components, and/or combinations thereof. It should be understood that, although the terms first, second, third, and the like may be used herein to describe various elements, components, regions, layers, and/or portions, these elements, components, regions, layers, and/or portions should not be limited by these terms. These terms are used to distinguish one element, component, region, layer, or portion from another element, component, region, layer, or portion. Thus, a first element, component, region, layer, or portion discussed below may be referred to as a second element, component, region, layer, or portion without departing from the teachings of the exemplary embodiments.

Referring to FIGS. 1 to 4, an embodiment of the present application provides a battery 100, including a housing 10, an electrode assembly 20 and an electrolyte accommodated in the housing 10, a first metal plate 40, and a second metal plate 50. The first metal plate 40 and the second metal plate 50 are both electrically connected to the electrode assembly 20 and extend from the housing 10 to connect to external components (not shown in the figure). FIGS. 2 to 4 show that the battery 100 includes one electrode assembly 20. In other embodiments, to achieve high voltage output, the battery 100 may include multiple electrode assemblies 20.

The housing 10 may be a packaging bag formed by encapsulating with a packaging film, meaning that the battery 100 is a pouch battery. Specifically, the housing includes a main body portion 11 and an encapsulation portion 12, where the main body portion 11 is provided with a cavity for accommodating the electrode assembly 20, and the encapsulation portion 12 extends from the edge of the main body portion 11 and is used to seal the main body portion 11. In other embodiments, the housing 10 is a metal housing, such as a steel housing or an aluminum housing.

As shown in FIG. 4, the electrode assembly 20 includes a first electrode sheet 21, a second electrode sheet 22, and a separator 23 disposed between the first electrode sheet 21 and the second electrode sheet 22. In this embodiment, the first electrode sheet 21, the separator 23, and the second electrode sheet 22 are alternately stacked in the fourth direction Z to form a laminated structure. The separator 23 is used to reduce the risk of a short circuit due to direct contact between the first electrode sheet 21 and the second electrode sheet 22. In some embodiments, the separator 23 includes at least one of the following polymers: polyolefin, polyvinylidene fluoride, polyethylene terephthalate, cellulose, polyimide, polyamide, spandex, or polyparaphenylene terephthalamide.

The first electrode sheet 21 includes a first current collector 211, a first active substance layer 212, and a first tab 213, where the first active substance layer 212 is disposed on at least one surface of the first current collector 211, and the first tab 213 electrically connects the first metal plate 40 and the first current collector 211. The second electrode sheet 22 includes a second current collector 221, a second active substance layer 222, and a second tab 223, where the second active substance layer 222 is disposed on at least one surface of the second current collector 221, and the second tab 223 electrically connects the second metal plate 50 and the second current collector 221. In this embodiment, the first tab 213 extends outward from an end of the region of the first current collector 211 away from the first active substance layer 212, and the second tab 223 extends outward from an end of the region of the second current collector 221 away from the second active substance layer 222. The first tab 213 may be welded to the region of the first current collector 211 away from the first active substance layer 212, and the second tab 223 may be welded to the region of the second current collector 221 away from the second active substance layer 222, which is not limited by the present application.

In some embodiments, the first electrode sheet 21 is a positive electrode sheet, and the second electrode sheet 22 is a negative electrode sheet. Specifically, the first current collector 211 includes at least one of Ni, Ti, Cu, Ag, Au, Pt, Fe, Al, or combinations thereof. The first active substance layer 212 includes a positive electrode active substance, where the positive electrode active substance may include at least one of lithium cobalt oxide, lithium manganese oxide, lithium nickel oxide, lithium nickel cobalt manganese oxide, lithium iron phosphate, lithium manganese iron phosphate, lithium vanadium phosphate, lithium vanadium oxide, lithium-rich manganese-based materials, lithium nickel cobalt aluminate, or combinations thereof. The second current collector 221 includes at least one of Ni, Ti, Cu, Ag, Au, Pt, Fe, Al, or combinations thereof. The second active substance layer 222 includes a negative electrode active substance, where the negative electrode active substance may be selected from at least one of graphite-based materials, alloy-based materials, lithium metal, or alloys thereof. The graphite-based materials may be selected from at least one of artificial graphite or natural graphite; and the alloy-based materials may be selected from at least one of silicon, silicon oxide, tin, or titanium sulfide.

Referring to FIG. 4, the electrode assembly 20 further includes a first surface 201 and a second surface 202 opposite to each other in the fourth direction Z, and a first end surface 203 and a second end surface 204 opposite to each other in the first direction X. The first end surface 203 and the second end surface 204 are both connected between the first surface 201 and the second surface 202. Referring to FIGS. 2 and 3, the first tab 213 and the second tab 223 are disposed at the second end surface 204. The end surfaces of the first electrode sheet 21, second electrode sheet 22, and separator 23 on the side opposite to the first tab 213 and the second tab 223 in the first direction X constitute the first end surface 203, and the end surfaces of the first electrode sheet 21, second electrode sheet 22, and separator 23 on the side where the first tab 213 and the second tab 223 are located in the first direction X constitute the second end surface 204. In this embodiment, the outermost layers of the electrode assembly 20 in the fourth direction Z are both the first electrode sheet 21, meaning that the first surface 201 is the surface of the outermost first electrode sheet 21 on one side in the fourth direction Z, and the second surface 202 is the surface of the outermost first electrode sheet 21 on the other side in the fourth direction Z. In other embodiments, the outermost layers of the electrode assembly 20 in the fourth direction Z may be the second electrode sheet 22 and/or the separator 23, which is not limited by the present application.

The battery 100 further includes a first layer 30 including an insulating material. The first layer 30 covers at least a portion of the first surface 201, at least a portion of the second surface 202, and the entire first end surface 203, and is adhered to the first surface 201, the second surface 202, and the first end surface 203, and the first layer 30 constrains the electrode assembly 20 in the fourth direction Z. In some embodiments, the first layer 30 is a single-sided adhesive or a double-sided adhesive.

In some embodiments, both the separator 23 and the first layer 30 are adhesive. The separator 23 is adhered to the adjacent first electrode sheet 21 and second electrode sheet 22, thereby constraining the electrode assembly 20 in the fourth direction Z. The first layer 30 is directly adhered to the first surface 201 and the second surface 202. Both the separator 23 and the first layer 30 may include at least one of the following polymers: vinylidene fluoride-hexafluoropropylene copolymer, vinylidene fluoride-trichloroethylene copolymer, polymethyl methacrylate, polyacrylic acid, polyacrylate, polyacrylonitrile, polyvinylpyrrolidone, polyvinyl acetate, ethylene-vinyl acetate copolymer, polyimide, polyethylene oxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, sodium carboxymethyl cellulose, lithium carboxymethyl cellulose, acrylonitrile-styrene-butadiene copolymer, polyvinyl alcohol, polyvinyl ether, polytetrafluoroethylene, polyhexafluoropropylene, styrene-butadiene copolymer, or polyvinylidene fluoride. These polymers can provide strong adhesion.

Referring to FIGS. 2 and 3, the first electrode sheet 21 is substantially sheet-shaped and includes a first edge 21a extending along the first direction X, a second edge 21b extending along the second direction Y, a third edge 21c extending along a third direction XY intersecting both the first direction X and the second direction Y and connecting the first edge 21a and the second edge 21b, a fourth edge 21d extending along the first direction X and opposite to the first edge 21a in the second direction Y, a fifth edge 21e extending along a fifth direction YX intersecting both the first direction X and the second direction Y and different from the third direction XY and connecting the second edge 21b and the fourth edge 21d, and a sixth edge 21f extending along the second direction Y and opposite to the second edge 21b in the first direction X. The first direction X, the second direction Y, and the fourth direction Z are mutually perpendicular. The first tab 213 extends from the sixth edge 21f along the first direction X, and the second tab 223 extends from an edge of the second electrode sheet 22 on the side of the sixth edge 21f along the first direction X. An included angle between the first edge 21a and the third edge 21c and an included angle between the second edge 21b and the third edge 21c are both obtuse. An included angle between the second edge 21b and the fifth edge 21e and an included angle between the fourth edge 21d and the fifth edge 21e are both obtuse. The third edge 21c and the fifth edge 21e form two corners of the first electrode sheet 21. As compared to the case where the second edge 21b is directly connected to the first edge 21a and the third edge 21c to form two corners of the first electrode sheet 21, in this embodiment, the third edge 21c and the fifth edge 21e are configured to form corners, increasing the area of the corners of the first electrode sheet 21, that is, the contact area between the corners of the first electrode sheet 21 and the housing 10, reducing the impact force of the corners of the electrode assembly 20 on the housing 10, thus reducing the risk of leakage due to cracking of the encapsulation portion 12 caused by the impact of the electrode assembly 20.

In this embodiment, the electrode sheets are formed by cutting, and after cutting, the corners of the electrode sheets are prone to curling or warping. In the present application, the first layer 30 is configured to address the curling or warping issues of the electrode plate caused by cutting. The present application is also applicable to curling or warping issues caused by other production methods of the electrode sheets. The first layer 30 is fixed to the first electrode sheet 21 and includes a first border 30a extending along the first direction X, a second border 30b extending along the second direction Y, and a third border 30c extending along the first direction X and opposite to the first border 30a in the second direction Y. The second border 30b connects the first border 30a and the third border 30c. The first border 30a and the first edge 21a are located on the same side of the electrode assembly 20 in the second direction Y, and the third border 30c and the fourth edge 21d are located on the other side of the electrode assembly 20 in the second direction Y.

When observed along the fourth direction Z, the first border 30a and the second border 30b each include a portion overlapping with the first electrode sheet 21, and the first border 30a further includes a portion spaced apart from the first edge 21a and the second edge 21b and connected to the third edge 21c. This arrangement of the first layer 30 enables the first layer 30 to constrain the third edge 21c forming the corner of the first electrode sheet 21 in the fourth direction Z, reducing the risk of curling or warping of the corner where the third edge 21c of the first electrode sheet 21 is located.

In some embodiments, when observed along the fourth direction Z, the third border 30c includes a portion overlapping with the first electrode sheet 21 and a portion spaced apart from the second edge 21b and the fourth edge 21d and connected to the fifth edge 21e. This arrangement of the first layer 30 enables the first layer 30 to constrain the fifth edge 21e forming the corner of the first electrode sheet 21 in the fourth direction Z, reducing the risk of curling or warping of the corner where the fifth edge 21e of the first electrode sheet 21 is located.

The third edge 21c includes a first end A1 connected to the first edge 21a and a second end A2 connected to the second edge 21b. The fifth edge 21e includes a third end A3 connected to the fourth edge 21d and a fourth end A4 connected to the second edge 21b. In the second direction Y, a first distance D1 from the first end A1 to the first border 30a is less than a second distance D2 from the second end A2 to the first border 30a, increasing the contact area between the first layer 30 and the third edge 21c, enhancing the adhesion between the first layer 30 and the third edge 21c, and further reducing the risk of curling or warping of the corner where the third edge 21c of the first electrode sheet 21 is located. In the second direction Y, a seventh distance D7 from the third end A3 to the third border 30c is less than an eighth distance D8 from the fourth end A4 to the third border 30c, increasing the contact area between the first layer 30 and the fifth edge 21e, thus further reducing the risk of curling or warping of the corner where the fifth edge 21e of the first electrode sheet 21 is located.

In the first direction X, a third distance D3 from the first end A1 to the second border 30b is greater than a fourth distance D4 from the first end A1 to the second end A2. In the first direction X, a ninth distance D9 from the third end A3 to the second border 30b is greater than a tenth distance D10 from the third end A3 to the fourth end A4.

The first border 30a and the third edge 21c are connected at a first intersection point O, and the third border 30c and the fifth edge 21e are connected at a second intersection point O′. In the first direction X, a fifth distance D5 from the first end A1 to the first intersection point O is less than a sixth distance D6 from the second end A2 to the first intersection point O. In the first direction X, an eleventh distance D11 from the third end A3 to the second intersection point O′ is less than a twelfth distance D12 from the fourth end A4 to the second intersection point O′.

Referring to FIGS. 2 and 3, when observed along the fourth direction Z, the second electrode sheet 22 includes a first exposed portion 22a exposed from the first electrode sheet 21, making the area of the second electrode sheet 22 greater than that of the first electrode sheet 21, and reducing the risk of lithium precipitation at the negative electrode. When observed along the fourth direction Z, the first layer 30 further includes a portion overlapping with the first exposed portion 22a, increasing the contact area between the first layer 30 and the electrode assembly 20, thereby enhancing the adhesion between the first layer 30 and the electrode assembly 20 and reducing the risk of the first layer 30 detaching.

Referring to FIGS. 2 and 3, when observed along the fourth direction Z, the separator 23 includes a second exposed portion 23a exposed from the first electrode sheet 21 and the second electrode sheet 22, making the area of the separator 23 greater than that of the first electrode sheet 21 and the second electrode sheet 22, and reducing the risk of a short circuit due to contact between the first electrode sheet 21 and the second electrode sheet 22. When observed along the fourth direction Z, the first layer 30 further includes a portion overlapping with the second exposed portion 23a. When observed along the fourth direction Z, the first border 30a intersects the third edge 21c, the second exposed portion 23a, and the first exposed portion 22a in sequence when extending away from the electrode assembly 20 along the first direction X, and the third border 30c intersects the fifth edge 21e, the second exposed portion 23a, and the first exposed portion 22a in sequence when extending away from the electrode assembly 20 along the first direction X.

Referring to FIG. 5, an embodiment of the present application further provides an electric apparatus 1, where the electric apparatus 1 includes the battery 100 as described above. The electric apparatus 1 of the present application may include, but is not limited to, notebook computers, pen-input computers, mobile computers, e-book readers, portable phones, portable fax machines, portable copiers, portable printers, head-mounted stereo headphones, video recorders, LCD TVs, portable cleaners, portable CD players, mini-disc players, transceivers, electronic notebooks, calculators, memory cards, portable recorders, radios, backup power sources, motors, automobiles, motorcycles, power-assisted bicycles, bicycles, lighting fixtures, toys, gaming consoles, clocks, power tools, flashlights, cameras, large household batteries, and lithium-ion capacitors.

The above disclosure represents only preferred embodiments of the present application and, certainly, should not be used to limit the scope of the present application. Therefore, equivalent changes made in accordance with the present application still fall within the scope covered by the present application.

What is claimed is:

1. A battery comprising an electrode assembly and a housing accommodating the electrode assembly, the electrode assembly comprising a first electrode sheet and a second electrode sheet that are stacked and adjacently disposed; wherein,
the first electrode sheet comprises a first edge extending along a first direction, a second edge extending along a second direction perpendicular to the first direction, and a third edge extending along a third direction intersecting both the first direction and the second direction, and the third edge comprising a first end connected to the first edge and a second end connected to the second edge;
the battery further comprises a first layer comprising an insulating material and adhered to the first electrode sheet, the first layer comprising a first border extending along the first direction and a second border extending along the second direction and connected to the first border;
when observed along a fourth direction perpendicular to both the first direction and the second direction, the first border and the second border each comprise a portion overlapping with the first electrode sheet, and the first border further comprises a portion spaced apart from the first edge and the second edge and connected to the third edge; and
the fourth direction is a stacking direction of the first electrode sheet and the second electrode sheet, and in the fourth direction, the first electrode sheet is located on an outermost side of the electrode assembly.

2. The battery according to claim 1, wherein in the second direction, a first distance from the first end to the first border is less than a second distance from the second end to the first border.

3. The battery according to claim 1, wherein in the first direction, a third distance from the first end to the second border is greater than a fourth distance from the first end to the second end.

4. The battery according to claim 1, wherein the first border and the third edge are connected at a first intersection point; and in the first direction, a fifth distance from the first end to the first intersection point is less than a sixth distance from the second end to the first intersection point.

5. The battery according to claim 1, wherein the first electrode sheet further comprises a fourth edge extending along the first direction and the fourth edge is opposite to the first edge in the second direction, and a fifth edge extending along a fifth direction intersecting both the first direction and the second direction and different from the third direction, and the fifth edge is connected to the third edge and the fourth edge, and the first layer further comprising a third border extending along the first direction and the third border is opposite to the first border in the second direction; and when observed along the fourth direction, the third border comprises a portion overlapping with the first electrode sheet and a portion spaced apart from the second edge and the fourth edge and connected to the fifth edge.

6. The battery according to claim 1, wherein when observed along the fourth direction, the second electrode sheet comprises a first exposed portion exposed from the first electrode sheet.

7. The battery according to claim 6, wherein when observed along the fourth direction, the first layer further comprises a portion overlapping with the first exposed portion.

8. The battery according to claim 1, wherein the electrode assembly further comprises a separator disposed between the first electrode sheet and the second electrode sheet, and when observed along the fourth direction, the separator comprises a second exposed portion exposed from the first electrode sheet and the second electrode sheet.

9. The battery according to claim 8, wherein when observed along the fourth direction, the first layer further comprises a portion overlapping with the second exposed portion.

10. The battery according to claim 1, wherein the electrode assembly further comprises a first surface and a second surface opposite to each other in the fourth direction, and a first end surface connecting the first surface and the second surface; the first layer being adhered to the first surface, the first end surface, and the second surface.

11. The battery according to claim 1, wherein the first electrode sheet is a positive electrode sheet, and the second electrode sheet is a negative electrode sheet.

12. The battery according to claim 1, wherein the first layer is a single-sided adhesive or a double-sided adhesive.

13. The battery according to claim 1, wherein the battery further comprises a first metal plate and a second metal plate, the first metal plate being electrically connected to the first electrode sheet and extending out of the housing along the first direction, and the second metal plate being electrically connected to the second electrode sheet and extending out of the housing along the first direction; and in the first direction, the first metal plate and the first layer are located on opposite sides of the electrode assembly, and the second metal plate and the first layer are located on opposite sides of the electrode assembly.

14. The battery according to claim 1, wherein the housing is a packaging bag.

15. The battery according to claim 1, wherein in the first direction, the outer surface of the first electrode sheet is a bare foil region.

16. An electric apparatus, comprising the battery according to claim 1.

17. The electric apparatus according to claim 16, wherein in the second direction, a first distance from the first end to the first border is less than a second distance from the second end to the first border.

18. The electric apparatus according to claim 16, wherein in the first direction, a third distance from the first end to the second border is greater than a fourth distance from the first end to the second end.

19. The electric apparatus according to claim 16, wherein the first border and the third edge are connected at a first intersection point; and in the first direction, a fifth distance from the first end to the first intersection point is less than a sixth distance from the second end to the first intersection point.

20. The electric apparatus according to claim 16, wherein the first electrode sheet further comprises a fourth edge extending along the first direction and the fourth edge is opposite to the first edge in the second direction, and a fifth edge extending along a fifth direction intersecting both the first direction and the second direction and different from the third direction, and the fifth edge is connected to the third edge and the fourth edge, and the first layer further comprising a third border extending along the first direction and the third border is opposite to the first border in the second direction; and when observed along the fourth direction, the third border comprises a portion overlapping with the first electrode sheet and a portion spaced apart from the second edge and the fourth edge and connected to the fifth edge.
